(19) United States
(12) Patent Application Publication
(10) Pub. No.: US 2025/0330756 A1
(43) Pub. Date: Oct. 23, 2025

(54) METHOD FOR DIRECTIONAL SIGNAL PROCESSING FOR A HEARING INSTRUMENT AND HEARING INSTRUMENT

(71) Applicant: Sivantos Pte. Ltd., Singapore (SG)

(72) Inventors: Homayoun KAMKAR-PARSI, Erlangen (DE); Jens HAIN, Erlangen (DE)

(21) Appl. No.: 19/185,519

(22) Filed: Apr. 22, 2025

(30) Foreign Application Priority Data
Apr. 22, 2024 (DE) 10 2024 203 743.5

(51) Int. Cl. H04R 25/00

(52) U.S. Cl. CPC H04R 25/405; H04R 25/407; H04R 2225/41

(57) ABSTRACT

A method performs directional signal processing for a hearing instrument. A first input signal is generated from an ambient sound by a first input transducer of the hearing instrument, and a second input signal is generated from the ambient sound by a second input transducer of the hearing instrument. On the basis of the first input signal and the second input signal, an angular direction of a sound source relative to a first reference direction, in particular to a frontal direction of a wearer of the hearing instrument, is detected at least approximately. On the basis of the first input signal and the second input signal, an orientation direction of the sound source, in particular relative to a second reference direction, is detected at least approximately.

### CROSS-REFERENCE TO RELATED APPLICATION

This application claims the priority, under 35 U.S.C. § 119, of German Patent Application DE 10 2024 203 743.5, filed Apr. 22, 2024; the prior application is herewith incorporated by reference in its entirety.

### FIELD AND BACKGROUND OF THE INVENTION

The invention relates to a method for directional signal processing for a hearing instrument, wherein on the basis of a first input signal and a second input signal of the hearing instrument, an angular direction of a sound source relative to a frontal direction of a wearer of the hearing instrument is detected at least approximately.

In hearing instruments, in particular in hearing aids in the narrower sense, an input signal is processed into an output signal by, in particular frequency-band-specific, signal processing and is supplied to an auditory system of a wearer of the hearing instrument, for instance by means of a loudspeaker. The signal processing may additionally be specially tailored to the wearer and in particular to their audiological requirements, for instance in the case of hearing aids in the narrower sense for treating a hearing impairment of the wearer.

The signal processing often also takes place directionally in the sense that multiple input signals are processed into the output signal such that sound from different spatial directions of the environment are incorporated into the output signal in different ways, i.e., that sound from some spatial directions is suppressed, and sound from other spatial directions is boosted in contrast.

For such directional microphonics, signal processing is usually based on particular models of an ambient situation, for instance that a sound source which is in a frontal direction of the wearer is in principle considered to be relevant or a useful signal source since it is assumed that the wearer will aim their gaze towards the sound sources relevant to them. A further assumption is, for example, to interpret noises from the rear half-space of the wearer as parasitic noises in principle, depending on their spectrum, if applicable.

Especially in complex conversational situations with multiple conversation partners, in particular in an environment with many additional parasitic noises (e.g., in a restaurant or the like, what is known as a “cocktail party” hearing situation), however, such signal processing reaches its limits since the distinction between sound signals which are relevant to the wearer and those which are irrelevant to the wearer is often too rough or too imprecise for this.

### SUMMARY OF THE INVENTION

It is therefore an object of the invention to indicate a method by means of which an additional possibility is provided for a hearing instrument to evaluate sound sources with regard to their relevance to a wearer of the hearing instrument.

According to the invention, the object recited is attained by a method for directional signal processing for a hearing instrument. A first input signal is generated from an ambient sound by a first input transducer of the hearing instrument, and a second input signal is generated from the ambient sound by a second input transducer of the hearing instrument. On the basis of the first input signal and the second input signal, an angular direction of a sound source relative to a first reference direction, in particular to a frontal direction of a wearer of the hearing instrument, is detected at least approximately, and wherein on the basis of the first input signal and the second input signal, an orientation direction of the sound source, in particular relative to a second reference direction, is detected at least approximately. Advantageous embodiments, some of which are inventive in themselves, are the subject of the dependent claims and of the following description.

A hearing instrument generally encompasses any device which is adapted to generate an electric input signal from an ambient sound by means of at least one, in particular acousto-electric, input transducer, to process the input signal by means of, in particular frequency-band-specific, amplification and/or compression into an output signal, and to generate a sound signal from the output signal and to supply it to an auditory system of a wearer of this device, in particular by means of an electro-acoustic output transducer (for example, a loudspeaker, what is known as a balanced metal case receiver, but also a bone conduction receiver). That is, in particular, a hearing instrument encompasses a headphone (e.g., as an “ear bud”), a headset, data glasses with a loudspeaker, etc., which are equipped with a corresponding input transducer. A hearing instrument, however, often also encompasses a hearing aid in the narrower sense, that is, an apparatus for treating a hearing impairment of the wearer, in which, during the processing of the input signal into the output signal, the former is amplified and/or compressed, in particular in a frequency-band-dependent manner, to at least partially compensate the hearing impairment of the wearer in a user-specific manner by means of an output sound signal generated from the output signal.

In particular, the hearing instrument may also be configured as a binaural hearing system with a first local apparatus and a second local apparatus, wherein in this case, the hearing instrument may preferably also have (at least) two further input transducers, wherein the first and the second input transducers are arranged in the first local apparatus, and the two further input transducers are arranged in the second local apparatus. The applicability of the described method is generally independent of this.

In particular, a first or second input transducer encompasses any device which is adapted to generate a corresponding electric signal from a sound signal. In particular, during the generation of the first or second input signals by the respective input transducer, preprocessing, e.g., in the form of linear preamplification and/or A/D conversion, may also take place. The correspondingly generated input signal is given in particular by an electric signal whose current and/or voltage fluctuations essentially represent the sound pressure fluctuations of the air.

In particular, an angular direction of a sound source relative to a frontal direction of the wearer is to be understood to mean that, by wearing the hearing instrument on the head as intended (also in the case of a binaural hearing system as a hearing instrument), in particular on or in an ear (in the case of a monaural hearing instrument), an unambiguous relation is established between the two input transducers and the frontal direction of the wearer. By means of corresponding directional processing of the two input signals, it may thus be detected, for instance via differences in propagation time of corresponding signal components in the first and second input signals, in which angular direction a sound source is arranged, wherein the angle is related to the first reference direction, which in turn is given by the described frontal direction or may be defined on the basis thereof.

In particular, an orientation direction of the sound source is to be understood to mean a direction in which the sound source emits its maximum sound energy or in which the emission maximum of the sound energy of the sound source lies. In the case of a speaker as the sound source, this direction normally equals the frontal direction of the speaker. In the case of a loudspeaker, the orientation direction is usually given by an axis of symmetry of the arrangement of the diaphragm(s). In particular, the orientation direction may be related to the first reference direction, that is, preferably to the frontal direction of the wearer of the hearing instrument, as a vectorial direction (that is, displaced towards the sound source) so that the vectors of the first and of the second reference directions are parallel. Preferably, however, the second reference direction is given by the angular direction. Due to the fixed ratio between the first and second reference directions, however, the definition of the second reference direction may preferably be chosen depending on a following application since all alternative definitions are equivalent to one another (except for a corresponding angular transformation).

In particular, approximate detection of the angular direction and/or the orientation direction encompasses that a plurality of at least three (and preferably more) discrete angle values are specified as a possible range of values for the respective direction, and that the angle value is determined which comes closest to the real-world angular direction or orientation direction, and the angle value is output as the detected angular or orientation direction.

At least approximate detection is to be understood to mean that the detection of the respective direction may be carried out either in the discrete angle values or continuously and in particular exactly (within the scope of the respective possibilities, which are contingent in particular on any effects of discretization, sample rates, and finite computing and storage capacities, etc.).

The detection of the angular or orientation direction on the basis of the first and the second input signals comprises in particular that the detection is performed directly on the signal components of the first and the second input signals, i.e., that a corresponding angle-dependent filter (e.g., a notch filter) for the detection of the pertinent direction is applied directly to the first and the second input signals, and/or a propagation time difference of signal contributions is ascertained directly in the first and second input signals. Preferably, a shading effect of the head may also be taken into account for such a filter for detection, in particular by means of one or more, in particular orientation-direction-dependent head-related transfer functions.

However, the detection of the angular or orientation direction on the basis of the first and the second input signals also comprises the fact that the filter is applied to a first intermediate signal and a second intermediate signal for the detection of the pertinent direction, and/or the propagation time difference of signal contributions in the first and second intermediate signals is ascertained. The first intermediate signal is preferably derived only from the first input signal (that is, without signal contributions of the second input signal being incorporated directly into the second intermediate signal), and the second intermediate signal is preferably derived directly from the second input signal (that is, preferentially without signal contributions of the first input signal in the second intermediate signal).

The intermediate signals may be generated by single-channel preprocessing from the respective input signals. However, the intermediate signals may also each be generated by directional preprocessing from the first and the second input signals, for instance, as a forward-directed and backward-directed cardioid signal.

The detection of the angular direction of the sound source may be upstream of the detection of the orientation direction or may also be carried out together with this.

The detection of the orientation direction of the sound source, which in particular also includes a direction of maximum emission of the sound energy, as well as the relation to the angular direction, simplifies a distinction as to whether the sound source is a parasitic noise source or a possible useful signal source for the wearer. In particular, a sound source may thus be interpreted as a parasitic noise source if, as a result of its orientation direction (at a given angular direction), only small parts of the sound energy are emitted towards the wearer of the hearing instrument. This may be distinguished, for instance, by means of corresponding angle bounds, starting from the sound source, etc.

Preferably, on the basis of the orientation direction of the sound source, it is detected to be a sound source relevant to the wearer. This, too, may be detected on the basis of corresponding angle bounds, starting from the sound source. Thus, e.g., it can be checked whether the orientation direction, as related to the angular direction (that is, the angular direction, which is preferentially inverse, of the sound source as the second reference direction), is more than, e.g., (±) 10° or more than, e.g., (±) 22.5° or more than (±) 45° (i.e., whether the amount of the deviation of the orientation direction from the angular direction is more than 10° or 22.5° or 45°). If this is not the case for the set bound, that is, the deviation is smaller, then the sound source is assumed to be aimed essentially towards the wearer of the hearing system and is classified as a sound source relevant to the wearer.

Preferably, a speaker is detected to be the sound source. The method is in principle also applicable to other types of sound sources, however, it demonstrates its specific advantages especially in the context of a speaker as the sound source, who may move during a conversation and, in particular, change their orientation with respect to the wearer. The speaker may be detected as such in particular on the basis of spectral features, i.e., the sound including their speech contributions is detected to be speech on the basis of characteristic spectral features (such as, e.g., formants).

More preferably, the speaker is then detected to be a conversation partner of the wearer on the basis of the orientation direction. This means in particular that the speaker detected to be the relevant sound source is then also detected to be in conversation with the wearer, in particular as long as the orientation direction of the conversation partner is sufficiently aimed towards the wearer.

Favorably, a directionality of the sound of the sound source is ascertained, wherein the orientation direction of the sound source is ascertained only if the directionality ascertained does not fall below a lower limit value. This helps prevent computing power from being wasted to detect a relevant sound source if, e.g., the sound source is perceivable only in a diffuse manner. The directionality may be ascertained in particular on the basis of spectral features of the sound, for example on the basis of detection of a diffuse sound component.

Appropriately, it is sensed whether the sound source is in a first region which is located in the front half-space of the wearer, wherein the detection of the orientation of the sound source is performed only if the sound source is in the first region. This helps prevent computing power from being wasted to detect a relevant sound source if the sound source is in a spatial region which is a priori to be assumed to be irrelevant to the wearer. The first region may preferably be chosen as the region [−67.5°, 67.5°], more preferably [−60°, 60°] as related to the first reference direction or the frontal direction of the wearer.

Advantageously, the approximate detection of the orientation direction is effected by a selection from a plurality of, preferably at least three, discrete core orientation directions. The orientation direction may in particular also be detected such that one of three orientation regions is detected: orientation direction facing the wearer, orientation direction directed past the wearer in front of them, orientation direction directed past the wearer behind them. To discern whether a sound source is relevant to the wearer, a higher resolution, that is, with a larger range of values of the orientation directions (with respect to the angular direction or the inverse angular direction), is often not required. Thus, more complex ascertaining, and in particular also more complex calculation operations, may be dispensed with.

It has been found to be further advantageous if a first plurality of angle-dependent filters, in particular two-channel or multi-channel filters, are provided, the underlying angles of which cover at least a partial region of the space. The first plurality of angle-dependent filters are each applied to the first and the second input signals and/or to a first and a second intermediate signals which are each derived from the first and second input signals, respectively, and a set of corresponding angle-dependent features is ascertained therefrom. The angular direction of the sound source is detected on the basis of the angle-dependent features. In particular, the angle-dependent features are quantitative features such that the features in relation to various angular directions may be ordered according to size. The angle-dependent filters “scan” the partial region of the space or the entire space so that on the basis of a maximum or minimum of the angle-dependent features, the angle associated with the pertinent feature may be ascertained as the angular direction.

As an angle-dependent feature, a sound level or a degree of attenuation of a sound from a sound source arranged in the pertinent angular direction is preferably ascertained. In particular, the angle-dependent filters are configured as notch filters which are applied directly to the first and the second input signals, or to a first and second intermediate signals respectively derived therefrom, and effect corresponding spatial filtering with the pertinent angle range so that maximum emphasis or maximum attenuation may be ascertained in relation to one of the angles.

In a further advantageous embodiment, for at least one angular direction, a second plurality of orientation-direction-dependent filters are provided, each corresponding to an orientation direction for the angular direction. The second plurality of orientation-direction-dependent filters are each applied to the first and the second input signals and/or to the first and the second intermediate signals, and a second set of corresponding orientation-direction-dependent features is ascertained therefrom. The orientation direction is detected on the basis of the orientation-direction-dependent features. In particular, the orientation-direction-dependent features are quantitative features such that the features in relation to various orientation directions may be ordered according to size.

The orientation-direction-dependent filters “scan” the space around the sound source in relation to the given angular direction so that in particular on the basis of a maximum or minimum of the orientation-direction-dependent features, the orientation direction associated with the pertinent feature may be ascertained.

Preferably, as an orientation-direction-dependent feature, a degree of attenuation of a sound from a sound source aimed in the pertinent orientation direction is ascertained. In particular, the orientation-direction-dependent filters are configured as notch filters which are applied directly to the first and the second input signals, or to a first and second intermediate signals respectively derived therefrom.

More preferably, for the degree of attenuation, a comparison signal which is generated by applying the pertinent angle-dependent and/or orientation-direction-dependent filter to the first and the second input signals and/or to the first and the second intermediate signals is compared with a reference signal which preferentially has omnidirectional directivity. Such a comparison may be implemented in a particularly simple manner, and the reference signal also affords a comparison variable for the entire sound level as a reference variable for the attenuation by the respective filter.

In particular, the reference signal is derived only from the first input signal. This helps ensure the omnidirectional directivity without any further signal processing steps.

Favorably, a plurality of discrete configurations is specified, each given by an associated angular direction from a first plurality of discrete angular directions for the sound source and by an associated orientation direction from a second plurality of discrete orientation directions. For each of the configurations, an orientation-direction-dependent filter is provided which is each applied to the first and the second input signals and/or to the first and the second intermediate signals, and a corresponding orientation-direction-dependent feature is ascertained therefrom for the respective configuration. The orientation direction is detected on the basis of the orientation-direction-dependent features ascertained.

This means in particular: Only a certain number of possible configurations considered to be relevant will be checked, wherein each configuration is given by one of multiple possible angular directions and an associated orientation direction (in particular as related to the respective angular direction or inverse angular direction), wherein in relation to an angular direction, exactly one or even multiple orientation directions (that is, one configuration or multiple configurations for this angular direction) may exist. This allows keeping the overhead low by considering only a reduced number of configurations (compared with a potentially far greater number of possibilities of configuration) in the first place and having to provide corresponding filters and ascertain the associated features.

Appropriately, an orientation-dependent head-related transfer function (ODHRTF) is provided for each orientation direction in relation to a given angular direction, wherein each of the ODHRTFs represents a transfer path for sound from the sound source which is arranged in a pertinent angular direction with said orientation direction, and wherein the orientation-direction-dependent filters are each formed on the basis of the respectively associated ODHRTF. This means in particular that the respective filter, e.g., as a notch filter, takes into account or preferably includes the associated ODHRTF from the sound source (at a given angular direction and given orientation direction) towards the first or second input transducers. This helps ensure precise mapping of the spatial propagation of the sound from the sound source to the respective input transducer so that spatial distortion effects, which could lead to imprecise determination of the angular or orientation direction, are avoided for the filter in the best possible way. The ODHRTF represents an expansion of the concept of the head-related transfer function (HRTF), which represents a transfer path for sound from a sound source arranged in a certain angular direction, however, unlike the ODHRTF, does not depend on the orientation direction of the sound source. Preferably, the individual ODHRTFs are measured and/or simulated in advance (that is, before the method itself) in a calibration.

Advantageously, the orientation direction is detected on the basis of the orientation-direction-dependent features by means of an artificial neural network. This means that the orientation-direction-dependent features are passed on as input variables to an artificial neural network, e.g., a recurrent neural network (RNN) or the like, and the neural network outputs the orientation direction ascertained at least approximately as an output variable. In particular, simultaneous processing of the input variables may take place, which leads to an improvement in runtime.

Favorably, an, or the, orientation-dependent head-related transfer function is provided for each orientation direction in relation to a given angular direction, wherein input variables are used for the artificial neural network which are derived on the basis of the first and/or second input signals filtered with the associated orientation-dependent head-related transfer function. This makes it possible, on the one hand, to calculate the orientation direction by means of an artificial neural network particularly suitable for this purpose, since this type of task is performable in a comparatively efficient manner even by smaller artificial neural networks and these may also be adapted for the task with comparatively little training effort (since there is only a small number of parameters in the case of small artificial neural networks). On the other hand, the process of signal processing for detecting the orientation direction may be shortened significantly by the use of acoustic features, such as, for example, the input signals filtered as described, as input variables.

The invention further recites a hearing instrument, containing a first input transducer for generating a first input signal from an ambient sound, a second input transducer for generating a second input signal from the ambient sound, and a signal processing unit. The hearing instrument is adapted to perform the method described above, and wherein in particular, the signal processing unit is adapted (by correspondingly equipping it with processor power and working memory addressable thereby, as well as by program commands) to perform the signal processing steps of the method described above.

The hearing instrument according to the invention shares the benefits of the method according to the invention. The advantages indicated for the method and for its developments may be transferred to the hearing instrument analogously.

Other features which are considered as characteristic for the invention are set forth in the appended claims.

Although the invention is illustrated and described herein as embodied in a method for directional signal processing for a hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block circuit diagram of a hearing instrument;

FIG. 2 is a top view of a hearing situation of a wearer of the hearing instrument of FIG. 1 with a speaker as a sound source;

FIG. 3 is a block diagram of a sequence of a method for determining an orientation direction of the speaker of FIG. 2;

FIG. 4 is a top view of multiple configurations, each given by specifically orientated speakers around the wearer of the hearing instrument of FIG. 1;

FIG. 5 is a diagram showing the effect of individual filters for the method of FIG. 3, applied to a configuration of FIG. 4; and

FIG. 6 show respective top views of various possible configurations in relation to three different angular directions of a speaker.

Corresponding parts and variables are each labelled with the same reference numerals throughout the figures.

### DETAILED DESCRIPTION OF THE INVENTION

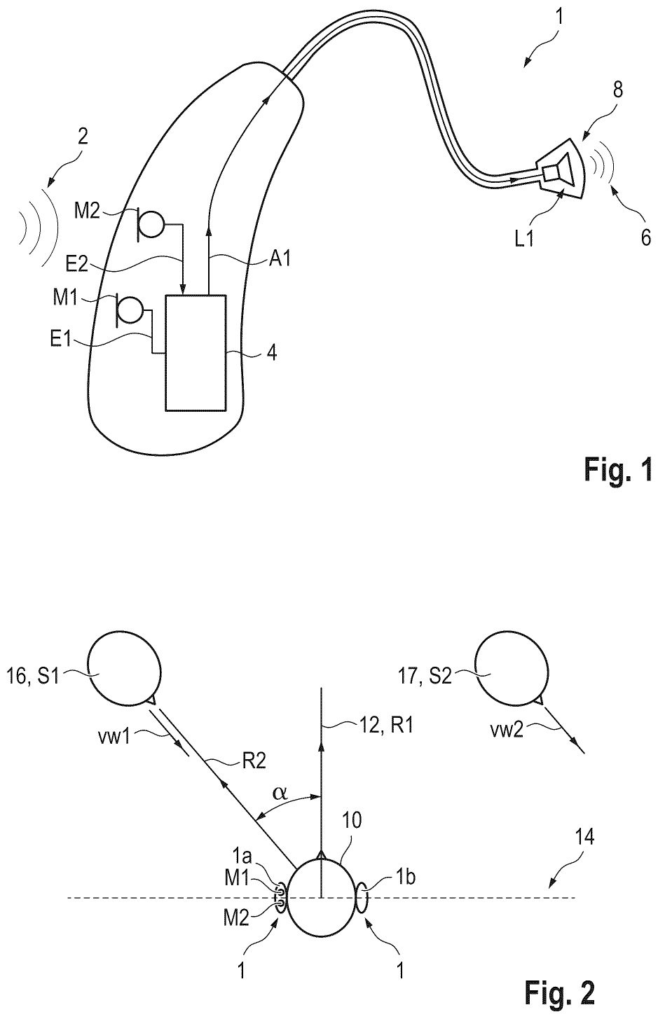

Referring now to the figures of the drawings in detail and first, particularly to FIG. 1 thereof, there is shown schematically a block circuit diagram of a hearing instrument 1 having a first input transducer M1 and a second input transducer M2. The first input transducer M1 and the second input transducer M2 are each given by corresponding microphones. The first input transducer M1 is adapted to generate a first input signal E1 from an ambient sound 2 during operation of the hearing instrument 1. Correspondingly, the second input transducer M2 is adapted to generate a second input signal E2 from the ambient sound 2 during operation of the hearing instrument 1. The first input signal E1 and the second input signal E2 are supplied to a signal processing unit 4, in which the two input signals E1, E2 are processed into an output signal A1, and in particular are amplified and/or compressed in a frequency-band-specific manner, wherein the signal processing of the two input signals E1, E2 into the output signal A1 takes place in particular in a direction-dependent manner, i.e., contributions of individual sound sources from different spatial directions may be amplified to different extents in the ambient sound. Furthermore, the signal processing may in particular take place according to audiological requirements of a wearer of the hearing instrument 1.

The hearing instrument 1 further has an output transducer L1 which is adapted to generate an output sound signal 6 from the output signal A1. The schematic depiction of the hearing instrument 1 in FIG. 1 shows what is known as a behind-the-ear (BTE) hearing aid with an earpiece 8 in which the output transducer L1 is arranged, however, the hearing instrument 1 is also conceivable as a structural form, in particular as an in-the-ear (ITE) hearing aid, an in-the-canal (ITC) hearing aid, a completely-in-the-canal (CIC) hearing aid, a receiver-in-the-canal (RIC) hearing aid, or in particular also as an earphone which is not exclusively or not primarily provided for treating a hearing impairment. In particular, the hearing instrument 1 may also be configured as a binaural hearing system with a first local apparatus and a second local apparatus (not depicted). In this case, in particular, the hearing instrument 1 may also have two further input transducers, wherein the two further input transducers are arranged in the second local apparatus. The applicability of the described method is generally independent of this.

FIG. 2 schematically depicts a top view of a hearing situation of a wearer 10 of the hearing instrument 1. The hearing instrument 1 may also be given by a binaural hearing system with a first local apparatus 1a and a second local apparatus 1b, wherein the two input transducers M1, M2 may be distributed to the two local apparatuses 1a, 1b (one input transducer M1, M2 each in each local apparatus 1a, 1b), or each local apparatus 1a, 1b may have two input transducers M1, M2 (the input transducers for the local apparatus 1b are not depicted). By arranging the two input transducers M1, M2 in the hearing instrument 1, a first reference direction R1 may be defined for wearing the hearing instrument 1 as intended, which is preferentially chosen in a frontal direction 12 of the wearer 10. A sound source 16, which is given by a speaker S1, is arranged in a front half-space 14 in an angular direction a with respect to the first reference direction R1. Now, to be able to detect whether the sound source 16 is a sound source relevant to the wearer 10 and thus the speaker S1 is a conversation partner of the wearer 10, an orientation direction vw1 of the sound source 16, in which the sound source 16 emits the maximum of its sound energy, is ascertained by the hearing instrument 1 on the basis of the first and the second input signals E1, E2 in a manner yet to be described. For the speaker 1 as the sound source 16, this orientation direction vw1 is synonymous with the speaking or gaze direction of the speaker S1.

The orientation direction vw1 is preferably defined relative to a second reference direction R2 to be chosen in a suitable manner. Presently, the second reference direction R2 is chosen as the (reversed) angular direction α of the speaker S1 but may in particular also be chosen to be identical to the first reference direction R1. A further sound source 17 is drawn in FIG. 2, which is given by a further speaker S2. The speaker S2 has not aimed their gaze direction towards the wearer 10, thus their orientation direction vw2 is aimed away from the wearer.

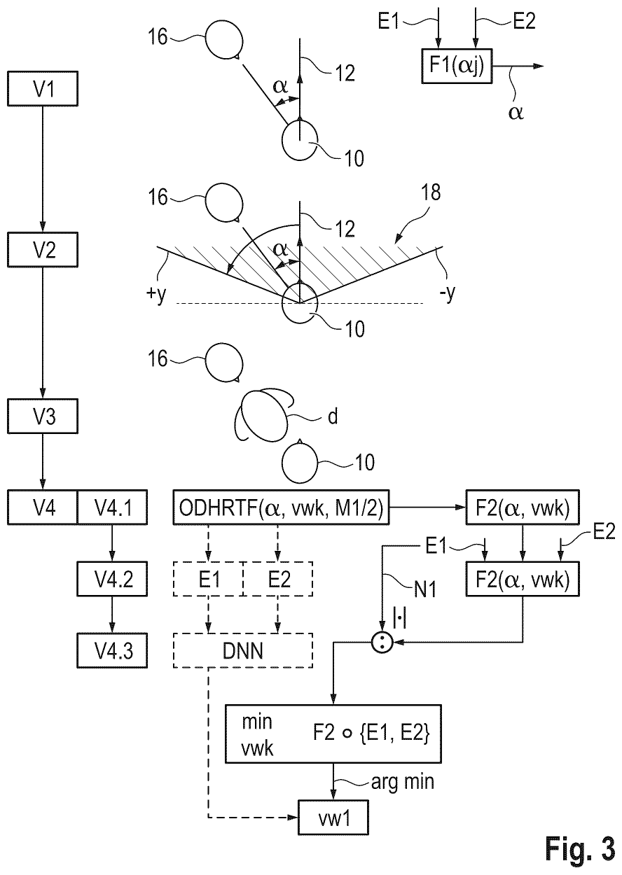

FIG. 3 schematically depicts the sequence of a method for the aforementioned determination of the orientation direction vw1 of the sound source 16 on the basis of a block diagram. The individual signal processing or signal analysis steps are preferably to be executed in the signal processing unit 14 of the hearing instrument 1, in particular on a correspondingly adapted, preferentially programmable, signal processor and/or on a circuit (for example an ASIC) adapted for this purpose in an application-specific manner. In the individual analysis steps, the first and the second input signals E1, E2 may be used directly, i.e., spatial filters or the like for detecting the angular and/or orientation directions of the sound source 16 are applied directly to the first and the second input signals. However, the first and the second input signals E1, E2 may also be further processed into at least two intermediate signals (not depicted) (for instance into a cardioid signal and an anti-cardioid signal), with at least partial retention of their spatial information, and the filters may be applied to these intermediate signals.

In a first method step V1, an angular direction a of the sound source 16 is ascertained on the basis of the first and the second input signals E1, E2. This corresponds to ascertaining what is known as a “direction of arrival” (DoA) and may take place, for instance, by ascertaining differences in propagation time and/or level in the two input signals E1, E2, and/or on the basis of spatial first filters F1 (αj) which are applied to the two input signals E1, E2 (or correspondingly to intermediate signals derived therefrom) and which are designed as notch filters such that they have a maximum attenuation at an angle αj. The individual first filters F1 (αj) may now “scan” the space by means of a variation of the angle argument αj.

Once the angular direction a has been ascertained, a method step V2 may optionally check on the basis of the angular direction α whether the sound source 16 is in a first region 18 which is located in the front half-space 14. The first region 18 may in particular be defined by a symmetrical angle range [−γ,γ] around the frontal direction 12, wherein γ is preferably to be selected from the (semi-open) interval [45°, 90°], more preferably from the interval [60°, 80°]. Then, the following method steps may in particular be executed only if the sound source 16 is in the first region 18, i.e., if the angular direction α is in the angle range [−γ,γ].

Further, in a likewise optional method step V3, a directionality d of the sound of the sound source 16 may be determined, for instance on the basis of spectral features in the input signals E1, E2. Then, the following method steps may in particular be executed only if the distance d of the sound source 16 does not fall below a specified lower limit (not drawn).

In the next method step V4, an orientation direction vw1 is now ascertained for the sound source 16. For this purpose, for the ascertained angular direction α, orientation-direction-dependent second filters F2 (α, vwk) are provided in a first intermediate step V4.1, i.e., different sets of second filters F2 (αi, vwk), F2 (αj, vwk) exist in relation to different angular directions αi, αj. In particular, for the second filters F2, an orientation-direction-dependent ODHRTF (α, vwk, M1/M2) from the sound source 16 arranged in the angular direction α to the first or second input transducer M1, M2, respectively, may be utilized. In a next intermediate step V4.2, for the individual orientation directions vwk, the second filters F2 (α, vwk) are applied to the first and the second input signals E1, E2 (application ° of the second filter F2 to the set {E1, E2} of the input signals) and also normalized via a reference signal N1, if applicable. In particular, the first or the second input signal E1, E2 may be used directly as the reference signal N1.

Finally, in an intermediate step V4.3, the minimum of the input signals E1, E2 filtered as stated with the respective second filters F2 (α, vwk) and normalized with the reference signal N1 is formed by means of the individual orientation directions vwk, and the associated argument arg min is determined as the orientation direction vw1 of the sound source 16. The determination may take place in particular approximately, namely in that only a limited number of orientation directions vwk is checked (e.g., k=1 . . . 3 or k=1 . . . 5). In particular, the orientation directions vw1 may be related to the (reversed) angular direction α so that for k=1 . . . 3, only the outcomes “aimed towards the wearer” (vw1=α or 180°+α), “aimed past the wearer in front of them”, “aimed past the wearer behind them” are defined as the value range of the orientation direction.

The orientation direction vw1 may also be determined by means of a correspondingly trained artificial neural network DNN (dashed signal path), which receives the input signals E1, E2 filtered with the orientation-direction-dependent ODHRTF (α, vwk, M1/M2) as input variables and outputs the orientation direction vw1 as the outcome.

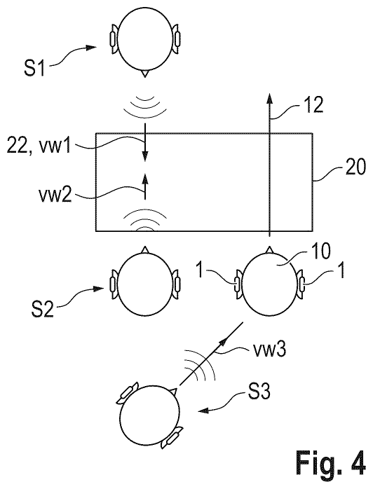

FIG. 4 schematically depicts a top view of multiple configurations in a conversation situation of the wearer 10, wherein each of these configurations is given by a speaker S1, S2, S3 and their particular orientation direction vw1, vw2, vw3. While a speaker S1 is seated diagonally across a table 20 from the wearer 10 but looks forward in their own frontal direction 22 (and thus their orientation direction vw1 is not aimed towards the wearer 10, but runs parallel to their frontal direction 12; first configuration), a speaker S2 is seated next to the wearer 10 with their gaze and thus their orientation direction vw2 directed towards the speaker S1 (second configuration). A speaker S3 is standing diagonally behind the wearer 10, with their orientation direction vw3 aimed towards the wearer 10 (third configuration). In a real-world, lively conversation situation, the speakers S1, S2, S3 are speaking at different times, sometimes also with mutual interruption.

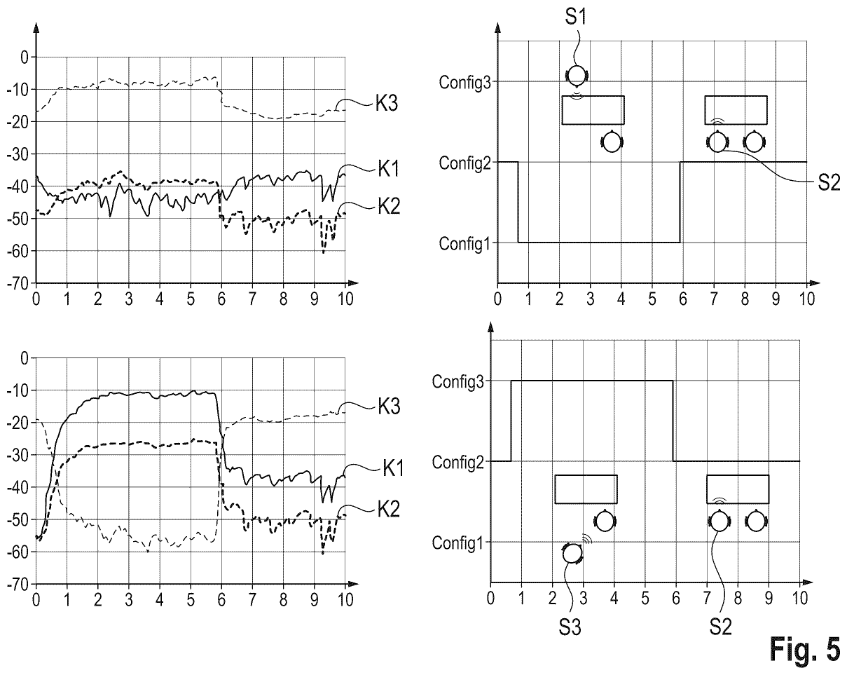

FIG. 5 now depicts the effect of individual second filters F2 applied to the individual configurations of FIG. 4 for the method of FIG. 3. In a first diagram at the top left, for the three configurations K1, K2, K3, the respective output variables of the second filter of the respective configuration (that is, with respect to the speaker in the given angular direction and with their orientation direction), applied to the first and the second input signals, are plotted against a time axis. As is evident, the first filter affords a close but perceivable minimum up to a point in time just before 6 s for the configuration K3, whereas after this point in time, the second filter affords a detectable minimum for the configuration K2. This implies that up to the point in time just before 6 s, the speaker S1 of the first configuration is active, and thereafter the speaker S2 of the second configuration is active. The corresponding result is depicted in the second diagram (top right) against the time axis.

In a third diagram at the bottom left, for the three configurations K1, K2, K3, the respective output variables of the second filter of the respective configuration are again plotted against the time axis. As is evident, the second filter affords a clear minimum up to a point in time just before 6 s for the configuration K3, whereas after this point in time, the second filter affords a clear minimum for the configuration K2. This implies that up to the point in time just before 6 s, the speaker S3 of the third configuration is active, and thereafter the speaker S2 of the second configuration is active. The corresponding result is depicted in the fourth diagram (bottom right) against the time axis.

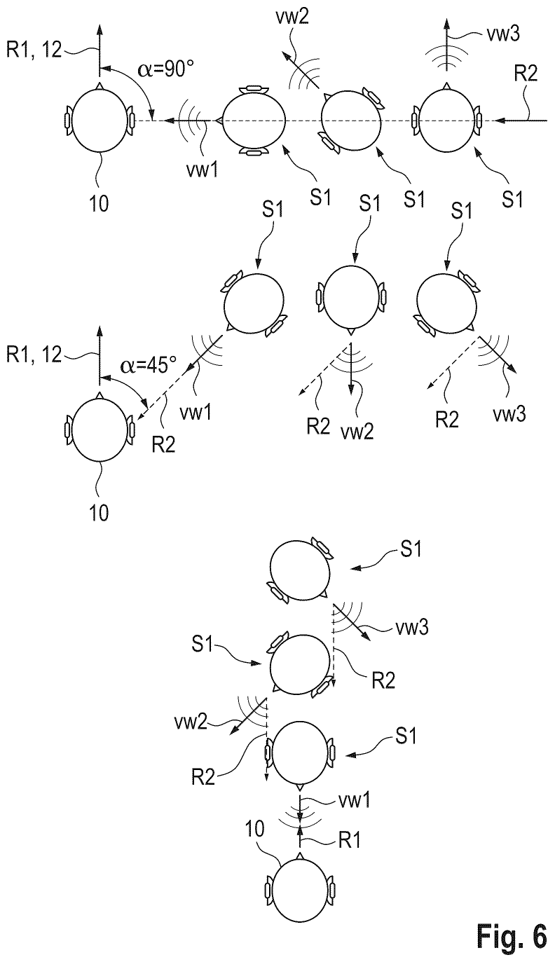

FIG. 6 shows various possible configurations regarding the orientation direction vw1-3 in relation to each of three different angular directions α of the speaker S1 (as related to the frontal direction 12 of the wearer 10).

The upper configurations show the speaker S1 in an angular direction of α=90° in relation to the first reference direction R 1 given by the frontal direction 12 of the wearer 10 of the hearing instrument 1. In the configuration shown on the left, the speaker S1 has an orientation direction vw1 of 0° as related to the second reference direction R2 given by the (reversed) angular direction α. In the configurations drawn next to it, the speaker S1 has an orientation direction vw2 of 45° or vw3 of 90° as related to the second reference direction R2.

The middle configurations show the speaker S1 in an angular direction of α=45° in relation to the first reference direction R1. In the configuration shown on the left, the speaker S1 has an orientation direction vw1 of 0° as related to the second reference direction R2. In the configurations drawn next to it, the speaker S1 has an orientation direction vw2 of 45° or vw3 of 90° as related to the second reference direction R2.

The bottom configurations show the speaker S1 in an angular direction of α=0° in relation to the first reference direction R1. In the bottom-most configuration, the speaker S1 has an orientation direction vw1 of 0° as related to the second reference direction R2 given by the (reversed) angular direction α. In the configurations drawn above it, the speaker S 1 has an orientation direction vw2 of 45° or vw3 of −45° as related to the second reference direction R2.

Although the invention has been illustrated and described in more detail by the preferred exemplary embodiment, the invention is not restricted by the disclosed examples and other variations may be derived from them by a person skilled in the art without departing from the scope of protection of the invention.

The following is a summary list of reference numerals and the corresponding structure used in the above description of the invention:
1 Hearing instrument
1a/b Local apparatus (of the hearing instrument)
2 Ambient sound
4 Signal processing unit
6 Output sound signal
8 Earpiece
10 Wearer
12 Frontal direction
14 Front half-space
16 Sound source
17 Sound source
18 First region
20 Table
22 Frontal direction
A1 Output signal
DNN Artificial neural network
E1/2 First/second input signal
F1 (Angle-dependent) first filter
F2 (Orientation-direction-dependent) second filter
L1 Output transducer
K1-3 Output variable of the second filter (for configurations 1-3)
M1/2 First/second input transducer
N1 Reference signal
R 1/2 First/second reference direction
S1-3 Speaker
V1-4 Method step
V4.1-3 Intermediate step
vw1-3, vwk Orientation direction
α, αj Angular direction

1. A method for directional signal processing for a hearing instrument, which comprises the steps of:
generating a first input signal from an ambient sound by a first input transducer of the hearing instrument;
generating a second input signal from the ambient sound by a second input transducer of the hearing instrument;
detecting at least approximately an angular direction of a sound source relative to a first reference direction based on the first input signal and the second input signal; and
detecting approximately an orientation direction of the sound source on a basis of the first input signal and the second input signal.

2. The method according to claim 1, wherein on a basis of the orientation direction of the sound source, it is determined whether the sound source is relevant to a wearer.

3. The method according to claim 2, which further comprises determining whether or not a speaker is the sound source.

4. The method according to claim 3, which further comprises determining whether or not the speaker is a conversation partner of the wearer on a basis of the orientation direction.

5. The method according to claim 1, which further comprises:
detecting a directionality of a sound of the sound source; and
ascertaining the orientation direction of the sound source only if the directionality detected does not fall below a lower limit value.

6. The method according to claim 1, which further comprises:
sensing whether the sound source is in a first region which is located in a front half-space of a wearer; and
performing the detection of the orientation direction of the sound source only if the sound source is in the first region.

7. The method according to claim 1, wherein a detection of the orientation direction is effected by a selection from a plurality of discrete core orientation directions.

8. The method according to claim 1, wherein:
a first plurality of angle-dependent filters are provided, underlying angles of which cover at least a partial region of a space;
the first plurality of angle-dependent filters are each applied to the first and the second input signals and/or to first and second intermediate signals which are each derived from the first and second input signals, respectively, and a set of corresponding angle-dependent features is ascertained therefrom; and
the angular direction of the sound source is detected on a basis of the set of corresponding angle-dependent features.

9. The method according to claim 8, wherein:
for at least one said angular direction, a second plurality of orientation-direction-dependent filters are provided, each corresponding to the orientation direction for the angular direction;
the second plurality of orientation-direction-dependent filters are each applied to the first and the second input signals and/or to the first and the second intermediate signals, and a second set of corresponding orientation-direction-dependent features is ascertained therefrom; and
the orientation direction is detected on a basis of the second set of corresponding orientation-direction-dependent features.

10. The method according to claim 1, wherein:
a plurality of discrete configurations is specified, each given by an associated said angular direction from a first plurality of discrete angular directions for the sound source and by an associated said orientation direction from a second plurality of discrete orientation directions;
for each of the discrete configurations, an orientation-direction-dependent filter is provided which is each applied to the first and the second input signals and/or to first and the second intermediate signals, and a corresponding orientation-direction-dependent feature is ascertained therefrom for a respective configuration of the discrete configurations; and
the orientation direction is detected on a basis of the corresponding orientation-direction-dependent features ascertained.

11. The method according to claim 9, wherein:
an orientation-dependent head-related transfer function is provided for each said orientation direction in relation to a given said angular direction;
each of the orientation-dependent head-related transfer functions represents a transfer path for sound from the sound source which is disposed in a pertinent said angular direction with the orientation direction; and
the orientation-direction-dependent filters are each formed on a basis of a respectively said associated orientation-dependent head-related transfer function.

12. The method according to claim 9, wherein as an angle-dependent feature and/or an orientation-direction-dependent feature, a degree of attenuation of a sound from the sound source disposed in a pertinent said angular direction and/or aimed in an associated said orientation direction is ascertained.

13. The method according to claim 12, wherein for the degree of attenuation, a comparison signal which is generated by applying the pertinent angle-dependent filter and/or an orientation-direction-dependent filter to the first and the second input signals and/or to the first and the second intermediate signals is compared with a reference signal which preferentially has omnidirectional directivity.

14. The method according to claim 13, which further comprises deriving the reference signal only from the first input signal.

15. The method according to claim 11, which further comprises detecting the orientation direction on the basis of the orientation-direction-dependent features by means of an artificial neural network.

16. The method according to claim 15, wherein:
the orientation-dependent head-related transfer function is provided for each said orientation direction in relation to a given said angular direction; and
input variables are used for the artificial neural network which are derived on a basis of the first and/or second input signals filtered with an associated said orientation-dependent head-related transfer function.

17. The method according to claim 1, wherein:
the first reference direction is a frontal direction of a wearer of the hearing instrument; and
the orientation direction of the sound source is detected, relative to a second reference direction, on a basis of the first input signal and the second input signal.

18. The method according to claim 7, wherein the detection of the orientation direction is effected by a selection from at least three said discrete core orientation directions.

19. A hearing instrument, comprising:
a first input transducer for generating a first input signal from an ambient sound;
a second input transducer for generating a second input signal from the ambient sound; and
a signal processor, wherein the hearing instrument is adapted to perform the method according to claim 1.
